(19) United States
(12) Patent Application Publication
(10) Pub. No.: US 2007/0286366 A1
(43) Pub. Date: Dec. 13, 2007

(54) Chat presence system

(76) Inventors: Scott Deboy, Hillsboro, OR (US); Kenneth Majors, Lake Oswego, OR (US)

Correspondence Address: CHERNOFF, VILHAUER, MCCLUNG & STENZEL, 1600 ODS TOWER, 601 SW SECOND AVENUE, PORTLAND, OR, 97204-3157, US

(21) Appl. No.: 11/725,657

(22) Filed: Mar. 19, 2007

Related U.S. Application Data
(60) Provisional application No. 60/783,266, filed on Mar. 17, 2006.

(51) Int. Cl. H04M 11/00

(52) U.S. Cl. 379/93.17

(57) ABSTRACT

A messaging program includes a window where a plurality of contacts are displayed within the window. The plurality of contacts are arranged as a plurality of different groups within the window. A plurality of contacts within each of the different groups is provided with the same status for each respective group, wherein the status provided for two different groups are different.

### CROSS-REFERENCE TO RELATED APPLICATIONS

This application claims the benefit of 60/783,266 filed Mar. 17, 2006.

### BACKGROUND OF THE INVENTION

The present invention relates to a chat presence system.

Users of computers tend to use their computers to communicate with one another through a variety of different communication mechanisms. One of the traditional techniques for communication is to send e-mails to one another or among a group of individuals. This is effective for passing on information but lacks the ability for timely effective interaction among the users, that would have occurred in a face-to-face discussion.

Another technique users of computers employ to communicate among one another is though the use of a blog. Users may post a question or a comment that is viewable by other users. In addition, users may post a response to the posts of others. In this manner, an on-line based record is created of the postings of various uses.

In many cases users of different computers interconnected to a network prefer to communicate in real time with one another. In order to facilitate real time communication, instant messaging communication tools may be used. MSN Messenger and Yahoo Messenger are examples of instant messaging programs.

Yahoo Messenger instant messaging program permits users to send text messages to one another. The users may send the text messages to one other individual at a time or to groups of individuals at the same time. The messaging program includes a window within which other “friends” are listed. When the friend is not available then the instant messaging program presents the friend with a first icon, such as a dark smiley face. When the friend is available then the instant messaging program presents the friend with a second icon, such as a bright smiley face. The messaging program may also permit the presentation of friends that are currently available and hide those that are not currently available. The user may select a status message that is displayed to other users, such as, available, on the phone, busy, stepped out, be right back, not at my desk. In addition, a user may select invisible so that they may use the messaging program while other viewers will not see them as available in the window.

### BRIEF DESCRIPTION OF THE SEVERAL VIEWS OF THE DRAWINGS

FIG. 1 is a network of users with chatting systems.

FIG. 2 is a messaging window.

FIG. 3 is a chat window.

FIG. 4 is a messaging window.

FIG. 5 is a messaging window.

FIG. 6 illustrates multiple messaging windows with multiple groups.

### DETAILED DESCRIPTION OF PREFERRED EMBODIMENT

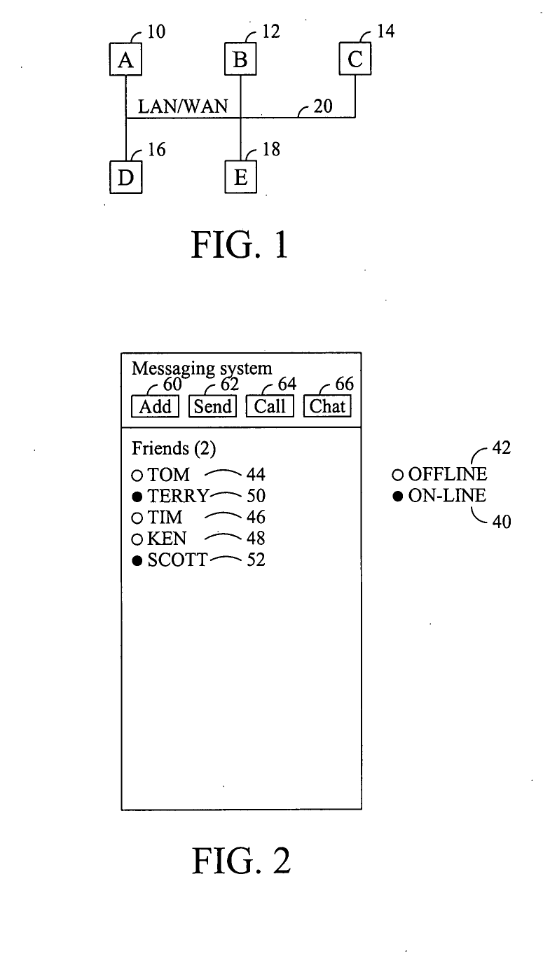

Referring to FIG. 1, a plurality of different users A 10, B 12, C 14, D 16, E 18 are interconnected together by a network 20, such as a Local Area Network, Internet, wireless network, mobile phone network, etc. The different users may operate any suitable communication device, such as a personal computer, a workstation, a cellular phone, a personal digital assistant, or otherwise. Each of the different users A 10, B 12, C 14, D 16, E 18 may use a messaging system for communication among one another.

Referring to FIG. 2, the messaging system may present a window on the user's screen. The window may include the ability for users to see whether their friends are “on-line” 40 or “off-line” 42. For example, Tom 44, Tim 46, and Ken 48 are off-line, while Terry 50 and Scott 52 are on-line. When Tom 44 becomes available by signing into the system or otherwise changing from “invisible” to “available”, then Tom's 44 icon will be updated to reflect that he is on-line 40. Similarly, when Scott 52 becomes unavailable 42 by signing off the system or otherwise changing from “available” to “invisible”, then Scott's 44 icon will be updated to reflect that he is off-line 42.

The user may “add” 60 additional friends using some identification mechanism of the other user. Similarly, the user may delete existing friends. The user may “send” 62 a message to another selected user or group of users. The user may also “send” 62 a message to another user by selecting that user from their list of friends. The user may also use the messaging system to call 64 another user's phone or any desirable phone. The user may select to “chat” 66 with multiple other users simultaneously in the same window.

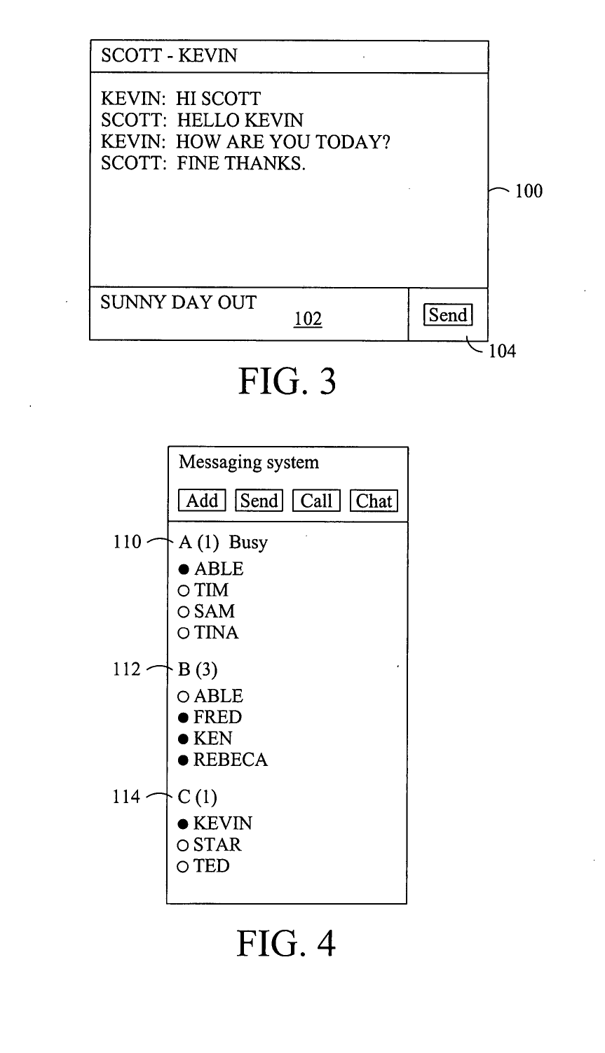

Referring to FIG. 3, the messaging system may present a window 100 on each user's display when sending text messages that includes the ability for users to communicate with one another, such as between Scott and Kevin. The users may type messages 102 that are sent 104 to one another, and which are displayed in the window 100. In addition, the users may communicate using audio and/or video and/or pictures in addition to (or separate from) the text messages.

Referring to FIG. 4, the messaging system may present a window that includes the ability to separate the user's contacts into a variety of different groups, such as group A 110, group B 112, and group C 114. Each of the different groups A 110, B 112, and C 114 may include a set of potential friends, as defined by the user. In this manner, the user may organize the friends into different groups such as “work”, “fishing buddies”, “family”, and “stock brokers”. In addition, the user may move a contact from one group to another group. The availability status of each of the contacts is displayed within the respective group. The user may change his status to his contacts on an individual basis, a group basis 110, 112, 114, or on a global basis. An example set of messages include, available, busy, stepped out, be right back, not at my desk, on the phone, or a new status message entered by the user. In addition, the user may elect to be invisible one or more others so that they are unaware that he is connected to the system.

On a group basis, where each group has more than one contact, the user may selectively set his status to all of the contacts on a group basis. An example set of messages for a group basis include, available, busy, stepped out, be right back, not at my desk, on the phone, or a new status message entered by the user. In addition, the user may elect to be invisible to others so that they are unaware that he is connected to the system. In this manner, the user's status may be selectively provided to different groups. This is especially useful when the user has a group of co-workers in a first group where the user wants his status available during the daytime, and a set of relatives in a second group where the user wants his status unavailable during the daytime. This status may likely be changed in the evening to unavailable to the group of co-workers and available to the group of relatives.

On an individual basis the user may selectively set his status to the selected contact. An example set of messages for a group basis include, available, busy, stepped out, be right back, not at my desk, on the phone, or a new status message entered by the user. In addition, the user may elect to be invisible to others so that they are unaware that he is connected to the system. This is especially useful when during a particular time frame that the user does not want to appear available to a particular user.

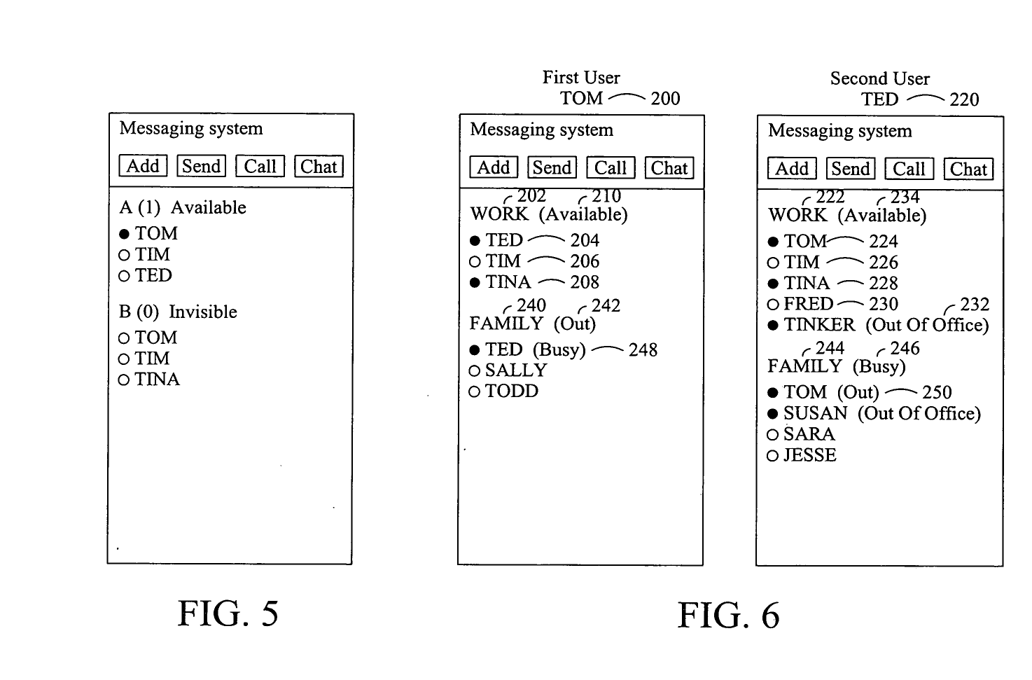

Referring to FIG. 5, while the user may be able to set the status on a group basis, however, a particular user, such as “Tom” may be in multiple groups. If both groups are set to the same message, then Tom will observe the user in the same manner. However in some cases, Group B may indicate that you are “off-line” to Tom while Group A may indicate that you are “on-line” to Tom; or Group B may indicate that you are “busy” to Tom while Group A may indicate that you are “available” to Tom. Hence, your status to be provided to Tom may be seemingly contradictory depending on the particular group.

Referring to FIG. 6, in some cases the relevant groups are consistent between users (at least with respect to the pair of respective users) such that each user has the same sets of groups, then the difference may be reflected in the different groups. The user Tom 200 may have a work group 202, including Ted 204, Tim 206, and Tina 208. Tom 200 may set his status for the group 202 to a desired status, such as available 210. Ted 204 and Tina 208 are both shown as being available to Tom 200. In particular, Ted 204 and Tina 208 are both shown as being available to Tom 200 within the group work 202.

The user Ted 220 may have a work group 222, including Tom 224 (see Tom 200), Tim 226, Tina 228, Fred 230, and Tinker 232. Ted 220 may set his status for the group 222 to a desired status, such as available 234. Tom 224 and Tina 228 are shown as available while Tinker 232 is shown as out of office 232. Tim 226 and Fred 230 are not shown signed into the system or otherwise available.

The user Tom 200 may have a second group named Family 240 where the status 242 has been set to out. The user Ted 220 has a second group named Family 244 where the status 246 has been set to busy. Ted's 220 family group 244 status is reflected in Tom's 220 family group 240 as busy 248. Tom's 200 family group 240 status is reflected in Ted's 220 family group 244 as out 250. In this manner, it may be observed that the status of a user may be reflected differently depending upon the groups. The relationships between the groups may be automatically defined, defined based upon the names of the groups, or otherwise manually defined by the users.

In many cases the user would prefer to have the same availability reflected to the same user without regard to the particular group they are in. In that case, a set of rules or preferences may be used to determine the availability to be presented to the other user that is a member of multiple groups.

If the same visible status message is presented to both groups, then the same status message may be presented to users who are in both groups (e.g., Tom).

If different visible status messages are presented to both groups, then the different status messages may be presented to users who are in both groups (e.g., Tom).

If the same invisible status message is presented to both groups, then the same invisible status message may be presented to users who are in both groups (e.g., Tom).

If a visible status message is provided to one group, and an invisible status message is provided to another group, then a rule may be used to determine which status to present in both groups. The preferred technique is to default to a visible status to the user in both groups. Also, the technique could be to default to an invisible status to the user in both groups. Moreover, the technique may permit the user to select whether to be invisible or visible to both groups, or permit the user to select the outcome of such a conflict.

In some cases, the messaging system may be integrated together with a conferencing system. In a conferencing system, the users sign in to share files, text messages, audio, video, and other information. The users may arrange themselves as a set of groups, each of which has access to different content. In this manner, the users of a group can automatically share the associated content with any particular project. Accordingly, the conferencing system would have a set of users for each group or otherwise project in the system.

The messaging system may be associated with the workspace environment, and in particular, the projects. In this manner, the chat system defines sets of groups based upon the projects and further defines the users in the groups based upon the users in the projects. In this manner, when a user signs into the chat system, the groups may be automatically determined based upon which projects the user is a member of. Also, the members of those groups may be automatically determined based upon those that are members of a project and/or currently signed into a project. The status message and availability for each group may be selected within the chat program or selected by settings made within the conferencing system which is then used as the settings within the chat program. This facilitates the interconnection between a collaborative environment and a messaging system.

The terms and expressions which have been employed in the foregoing specification are used therein as terms of description and not of limitation, and there is no intention, in the use of such terms and expressions, of excluding equivalents of the features shown and described or portions thereof, it being recognized that the scope of the invention is defined and limited only by the claims which follow.

We claim:

1. A messaging program comprising:
(a) a window;
(b) a plurality of contacts displayed within said window;
(c) said plurality of contacts arranged as a plurality of different groups within said window;
(d) a plurality of contacts within each of said different groups provided with the same status for each respective said group, wherein the status provided for two different groups are different.
